(19) United States
(12) Patent Application Publication
(10) Pub. No.: US 2006/0061523 A1
(43) Pub. Date: Mar. 23, 2006

(54) Plasma display device and driving method thereof

(75) Inventors: Joon-Yeon Kim, Suwon-si (KR); Jeong-Nam Kim, Suwon-si (KR); Gab-Sick Kim, Suwon-si (KR); Sung-Chun Cho, Suwon-si (KR)

Correspondence Address: H.C. PARK & ASSOCIATES, PLC, 8500 LEESBURG PIKE, SUITE 7500, VIENNA, VA, 22182, US

(73) Assignee: Samsung SDI Co., Ltd.

(21) Appl. No.: 11/225,001

(22) Filed: Sep. 14, 2005

(30) Foreign Application Priority Data
Sep. 21, 2004 (KR) 10-2004-0075433

(51) Int. Cl. G09G 3/28

(52) U.S. Cl. 345/67

(57) ABSTRACT

In a plasma display device and driving method thereof, middle electrodes are formed between X electrodes for receiving a sustain pulse voltage and Y electrodes. A reset waveform and a scan pulse voltage are applied to the middle electrodes. A short-gap discharge is performed between the X electrode and the middle electrode in the earlier stage of a sustain discharge period, and a long-gap discharge is normally performed between the X electrode and the Y electrode after the earlier stage of the sustain discharge period, thereby performing stable discharge. Further, the number of switches of the M electrode driver may be reduced by floating the M electrode and applying a rising ramp waveform to the Y electrode in the reset period, thereby increasing the voltage at the M electrode.

### CROSS-REFERENCE TO RELATED APPLICATION

This application claims priority to and the benefit of Korean Patent Application No. 10-2004-0075433, filed on Sep. 21, 2004, which is hereby incorporated by reference for all purposes as if fully set forth herein.

### BACKGROUND OF THE INVENTION

1. Field of the Invention

The present invention relates to a plasma display device.

2. Discussion of the Background

Generally, a plasma display device utilizes a plasma panel display (PDP) to display letters or images by plasma generated by a gas discharge, and the PDP may have millions of pixels arranged in a matrix format depending on its size. The PDP may be a direct current (DC) PDP or an alternating current (AC) PDP according to applied driving voltage waveforms and discharge cell structures.

The DC PDP's electrodes are exposed in a discharge space in which current flows while a voltage is applied. Hence, a resistor is provided to control the current. On the other hand, the AC PDP has a dielectric layer covering the electrodes so that the current is controlled since a capacitance component is formed, and the AC PDP has a longer lifespan than the DC PDP since the dielectric layer protects the electrodes from collision with ions during discharging.

FIG. 1 is a diagram showing a conventional arrangement of PDP electrodes.

As FIG. 1 shows, the PDP electrodes have an (m×n) matrix configuration. Address electrodes A1 to Am are arranged in the column direction, and Y electrodes Y1 to Yn and X electrodes X1 to Xn are alternately arranged in the row direction. A discharge cell 20 is formed by an address electrode and an X and Y electrode pair.

FIG. 2 shows a conventional driving waveform for a PDP.

Referring to FIG. 2, a subfield includes a reset period, an address period, and a sustain period.

The reset period is for erasing the wall charge state of a previous sustain discharge and setting wall charges so as to stably perform the following addressing operation.

The address period is for selecting turn-on/turn-off cells (i.e., cells to be turned on or off) on the PDP and accumulating wall charges at the turn-on cells (i.e., addressed cells).

The sustain period is for alternately applying a sustain discharge voltage to the X electrodes and the Y electrodes, and performing a discharge for displaying an image on the addressed cells.

However, in the conventional plasma display device, an insufficient discharge may occur since insufficient priming particles may be generated in the selected discharge cells when applying a first sustain pulse after the address period.

In the sustain period, the same magnitude sustain discharge voltage is alternately applied to the X electrode and the Y electrode to perform the sustain discharge. Hence, in this case, it is desirable to apply symmetric waveforms to the X electrode and the Y electrode in the sustain discharge period.

However, a Y electrode driving circuit differs from an X electrode driving circuit since the waveform applied to the Y electrode differs from the waveform applied to the X electrode in the reset period and the address period (an additional reset and scan waveform is applied to the Y electrode) in the conventional plasma display device. Accordingly, the X and Y electrode driving circuits do not have matching impedance, the waveform alternately applied to the X electrode and the Y electrode may be distorted in the sustain discharge period, and an insufficient discharge may occur.

The above information disclosed in this Background section is only for enhancement of understanding of the background of the invention and therefore, it may contain information that does not form the prior art that is already known in this country to a person or ordinary skill in the art.

### SUMMARY OF THE INVENTION

The present invention provides a plasma display device and driving method thereof that may prevent insufficient discharges.

Additional features of the invention will be set forth in the description which follows, and in part will be apparent from the description, or may be learned by practice of the invention.

The present invention discloses a method for driving a plasma display device including a plurality of discharge cells, a discharge cell including a first electrode, a second electrode, and a third electrode arranged between the first electrode and the second electrode. In a reset period, a voltage at the first electrode is gradually increased from a first voltage to a second voltage, a voltage at the third electrode is gradually increased from a third voltage to a fourth voltage, and the voltage at the third electrode is gradually decreased from a fifth voltage to a sixth voltage. In an address period, a scan voltage is selectively applied to the third electrode. In a sustain period, a sustain discharge pulse is alternately applied to the first electrode and the second electrode.

The present invention also discloses a plasma display device including a PDP and a driving circuit. The PDP includes a first electrode and a second electrode for respectively receiving a sustain discharge voltage pulse, and a third electrodes formed between the first electrode and the second electrode. The driving circuit outputs signals for driving the first, second and third electrodes. The driving circuit includes a first electrode driver and a third electrode driver. The first electrode driver includes a first switch and a second switch coupled in series between a first power source for supplying a first voltage that is a higher voltage of the sustain discharge pulse and a second power source for supplying a second voltage that is a lower voltage of the sustain discharge pulse, and a third switch coupled between a third power source for supplying a third voltage and the first electrode, a node of the first and second switches being coupled with the first electrode, and the third switch gradually increasing a voltage at the first electrode. The third electrode driver includes a fourth switch coupled between a fourth power source for supplying a fourth voltage and the third electrode, and gradually decreases a voltage at the third electrode. In a reset period, the voltage at the third electrode is gradually decreased by turning on the fourth switch after the voltage at the third electrode is gradually increased by turning on the third switch while the third electrode is floated.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 shows an electrode arrangement diagram of a conventional PDP.

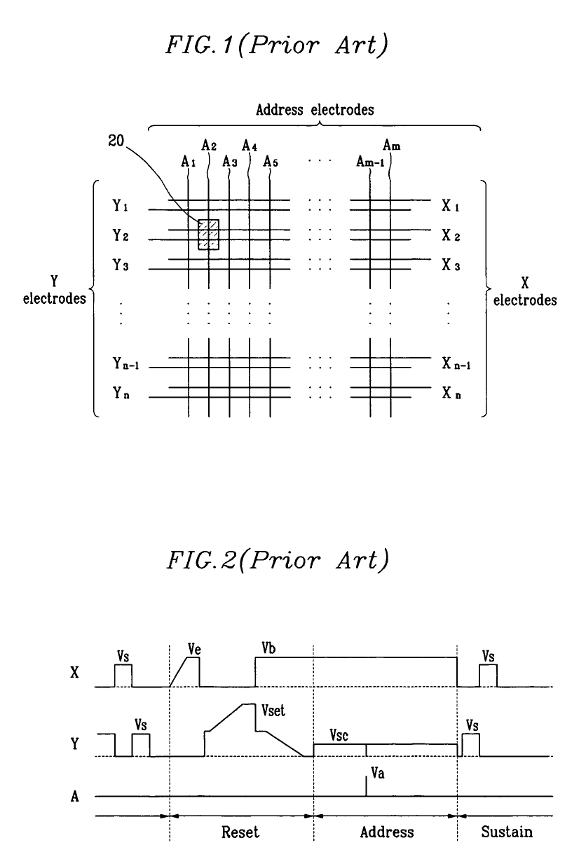

FIG. 2 shows a driving waveform diagram of a conventional plasma display device.

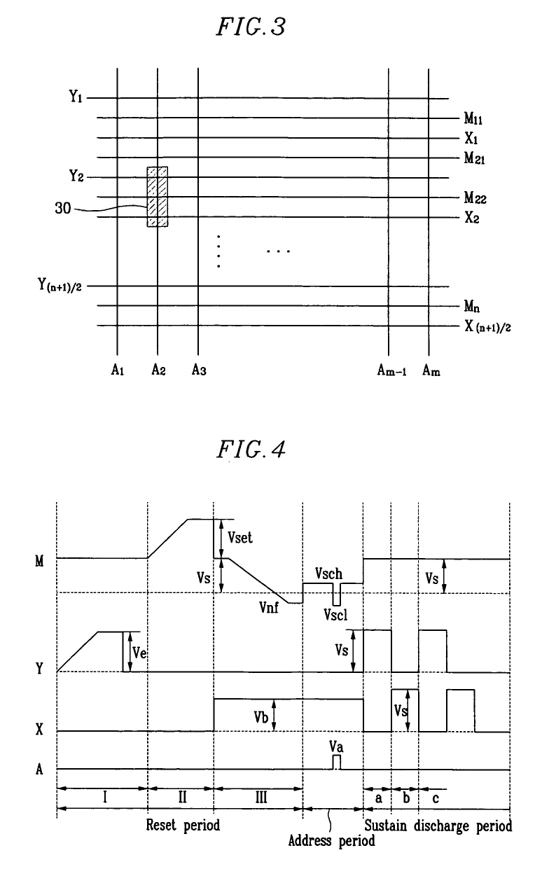

FIG. 3 shows an electrode arrangement diagram of a plasma display device according to an exemplary embodiment of the present invention.

FIG. 4 shows a driving waveform diagram of a plasma display device according to a first exemplary embodiment of the present invention.

FIG. 5A, FIG. 5B, FIG. 5C, FIG. 5D, and FIG. 5E show wall charge distribution diagrams for the driving waveform of FIG. 4 according to an exemplary embodiment of the present invention.

FIG. 6 and FIG. 7 respectively show a plasma display device and an electrode arrangement of the PDP according to a first exemplary embodiment of the present invention.

FIG. 8 shows a driving waveform diagram of a plasma display device according to a second exemplary embodiment of the present invention.

FIG. 9 shows a circuit diagram for the Y electrode driver, the X electrode driver, and the M electrode driver for generating the driving waveforms of FIG. 8 according to an exemplary embodiment of the present invention.

FIG. 10 shows a circuit diagram for the Y electrode driver, the X electrode driver, and the M electrode driver for generating the driving waveforms of FIG. 8 according to another exemplary embodiment of the present invention.

### DETAILED DESCRIPTION OF THE ILLUSTRATED EMBODIMENTS

Exemplary embodiments of the present invention will hereinafter be described in detail with reference to the accompanying drawings.

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification. As used herein, erase, erased, and erasing do not necessarily require removal of all traces of the thing being erased.

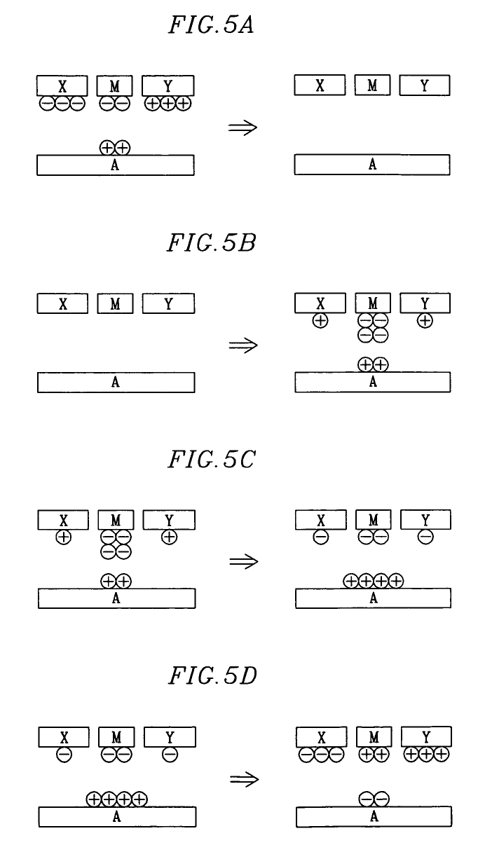

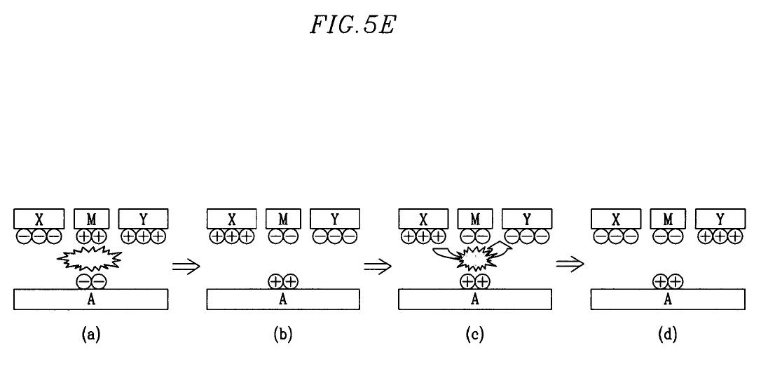

A plasma display device according to an exemplary embodiment of the present invention will now be described with reference to FIG. 3 and FIG. 4.

FIG. 3 shows an electrode arrangement diagram of a plasma display device according to an exemplary embodiment of the present invention.

As shown in FIG. 3, a plasma display panel (PDP) according to an exemplary embodiment of the present invention may have address electrodes A1 to Am arranged substantially in parallel in the column direction, (n+1)/2 Y electrodes Y₁ to Y_{(n+1)/2} and (n+1)/2 X electrodes X₁ to X_{(n+1)/2}, and n middle electrodes (M electrodes). That is, the M electrodes are arranged between the Y electrodes and the X electrodes, and the Y electrode, the X electrode, the M electrode, and an address electrode correspond to a single discharge cell 30 to thus form a 4-electrode structure.

In this case, a sustain discharge voltage waveform is applied to the X electrode and the Y electrode, and a reset waveform and a scan pulse voltage are applied to the M electrode.

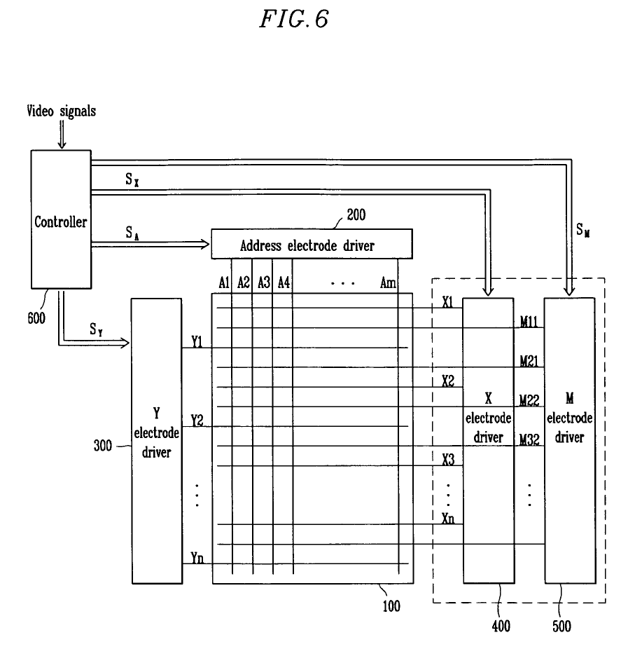

FIG. 4 shows a driving waveform diagram of a plasma display device according to a first exemplary embodiment of the present invention, and FIG. 5A, FIG. 5B, FIG. 5C, FIG. 5D, and FIG. FIG. 5E show wall charge distribution diagrams for the driving waveform of FIG. 4. A driving method according to an exemplary embodiment of the present invention will now be described with reference to FIG. 4 and FIG. 5A to FIG. 5E.

Referring to FIG. 4, a subfield may include a reset period, an address period, and a sustain period.

The reset period has an erase period I, an M electrode rising waveform period II, and an M electrode falling waveform period III.

Erase Period I

In the erase period I, wall charges formed in the previous sustain discharge period are erased. It is assumed that a sustain discharge voltage pulse is applied to the X electrode, and that a voltage (e.g., ground voltage) lower than the voltage applied to the X electrode is applied to the Y electrode in the final part of the sustain period. As shown in FIG. 5A, positive wall charges are formed at the Y electrode and the address electrode, and negative wall charges are formed at the X electrode and the M electrode.

In the erase period I, a waveform, such as, for example, a ramp waveform or a logarithmic waveform, that gradually increases from the ground voltage to the voltage of Ve is applied to the Y electrode while biasing the M electrode with the voltage of Vs. Accordingly, as FIG. 5 A shows, the wall charges formed in the sustain discharge period are erased. As used herein, “gradually” increasing or decreasing a voltage level refers to non-pulse like transitions from one voltage level to another.

M electrode Rising Waveform Period II

In this period, a waveform, such as, for example, a ramp waveform or a logarithmic waveform, that gradually increases from the voltage of Vs to the voltage of Vs+Vset is applied to the M electrode while biasing the X and Y electrodes with the ground voltage. While applying the rising waveform, a weak reset discharge occurs in the discharge cells from the M electrode to the address electrode, the X electrode, and the Y electrode, respectively. Consequently, as shown in FIG. 5B, negative wall charges accumulate at the M electrode and positive wall charges accumulate at the address electrode, the X electrode, and the Y electrode.

M Electrode Falling Waveform Period III

In the latter part of the reset period, a waveform, such as, for example, a ramp waveform or a logarithmic waveform, that gradually decreases from the voltage of Vs to the negative voltage of Vnf is applied to the M electrode while biasing the X electrode with the voltage of Vb and grounding the Y electrode.

A weak reset discharge occurs at the discharge cells while the M electrode voltage falls. In this case, since the M electrode falling waveform period III decreases the wall charges that are accumulated during the M electrode rising waveform period II, it is advantageous for the address discharge to lengthen the falling waveform (i.e., to control the gradient to be more gentle) to more precisely control the decreased amount of wall charges.

The wall charges accumulated at the electrodes of the cells are substantially equivalently erased when applying the falling waveform to the M electrode, and as shown in FIG. 5C, positive wall charges accumulate at the address electrode and negative wall charges accumulate at the X electrode, the Y electrode, and the M electrode.

Address Period (Scan Period)

In the address period, while biasing a plurality of M electrodes with the voltage of Vsch, a scan pulse is applied to the M electrodes by sequentially applying a scan voltage (e.g., a voltage Vscl), and the address voltage of Va is simultaneously applied to cells to be discharged (i.e., turned-on cells) on the address electrode. In the address period, the X electrode is biased with the voltage of Vb, and the Y electrode is grounded (i.e., the voltage applied to the X electrode is higher than the voltage applied to the Y electrode).

Accordingly, a discharge occurs between the M electrode and the address electrode, and a discharge also occurs at the X electrode and the Y electrode. Consequently, as shown in FIG. 5D, positive wall charges accumulate at the Y electrode and the M electrode, and negative wall charges accumulate at the X electrode and the address electrode.

Sustain Discharge Period

In the sustain discharge period, a sustain discharge voltage pulse is alternately applied to the X electrode and the Y electrode while biasing the M electrode with the sustain discharge voltage of Vs. A sustain discharge occurs at selected discharge cells.

In this instance, the sustain discharge occurs because of different discharge mechanisms in the earlier stage and the normal stage of the sustain discharge period. For better understanding and ease of description, the discharge that occurs at the earlier stage of the sustain discharge period will be referred to as a short-gap discharge, and the discharge that occurs at the normal stage thereof will be referred to as a long-gap discharge.

Short-gap Discharge

At the beginning of the sustain discharge period, as shown by (a) and (b) of FIG. 5E, a positive voltage pulse is applied to the Y electrode, a negative voltage pulse is applied to the X electrode (where the signs of + and − represent relative signs for comparing the respective voltages applied to the X electrode and the Y electrode, and an application of a positive pulse voltage to the Y electrode indicates the application of a voltage to the Y electrode that is greater than the voltage at the X electrode), and a positive voltage pulse is applied to the M electrode. Therefore, a discharge occurs between the X electrode and the Y electrode, and also between the M electrode and the X electrode, which differs from the prior art in which the discharge only occurs between the X electrode and the Y electrode. In particular, the electric field applied between the M electrode and the X electrode is greater than the electric field applied between the X electrode and the Y electrode because the distance between the M electrode and the X electrode is shorter than the distance between the X electrode and the Y electrode. Therefore, the discharge between the M electrode and the X electrode is dominant over the discharge between the X electrode and the Y electrode. Hence, the discharge between the M electrode and the X electrode is referred to as a short-gap discharge because it is the dominant discharge in the earlier stage of the sustain discharge period.

Therefore, since a short-gap discharge performed by applying a relatively higher electric field is generated in the earlier stage of the sustain discharge period according to the first exemplary embodiment of the present invention, a normal discharge may be performed when insufficient priming particles are generated in the discharge cell when applying the first sustain pulse after the address period.

Long-gap Discharge

Since the voltage at the M electrode is biased with the voltage of Vs after applying the first sustain pulse of the sustain discharge period, the discharge between the M electrode and the X electrode or the discharge between the M electrode and the Y electrode (i.e., short-gap discharge) becomes less dominant, and the discharge between the X electrode and the Y electrode becomes the dominant discharge. Further, the input image is displayed according to the number of discharge pulses alternately applied to the X electrode and the Y electrode.

That is, as shown by (d) in FIG. 5E, negative wall charges remain accumulated at the M electrode, and negative wall charges and positive wall charges alternately accumulate at the X electrode and the Y electrode in the normal-state sustain discharge period.

In the earlier stage of the sustain discharge period, a normal discharge may be performed when insufficient priming particles are provided since the discharge is the short-gap discharge between the X electrode and the M electrode (or between the Y electrode and the M electrode), and a stable discharge may be performed in the normal state since the discharge is the long-gap discharge between the X electrode and the Y electrode.

Also, according to the first exemplary embodiment of the present invention, substantially symmetrical voltage waveforms may be applied to the X electrode and the Y electrode, and hence, circuits for driving the X electrode and the Y electrode may be similar. Therefore, a stable discharge may be provided by reducing the distortion of the pulse waveforms applied to the X electrode and the Y electrode in the sustain discharge period because the difference of circuit impedance between the X electrode and Y electrode may be substantially eliminated.

Also, according to the first exemplary embodiment of the present invention shown in FIG. 4, the circuits can be driven when the waveforms applied to the X electrode and the Y electrode are changed with each other, and the same can also be driven when the waveforms applied to the X electrode and the Y electrode are changed with each other in the address period.

Therefore, the reset waveform and the scan pulse waveform are mainly applied to the M electrode, and the sustain voltage waveform is mainly applied to the X electrode and the Y electrode. In this case, the reset waveform applied to the M electrode includes the reset waveform shown in FIG. 4, as well as various types of reset waveforms used by the 3-electrode structure.

Application of the above-noted various reset waveforms to the 4-electrode structure according to the first exemplary embodiment of the present invention may be easily realized by a person of an ordinary skill in the art, and no corresponding description will be provided.

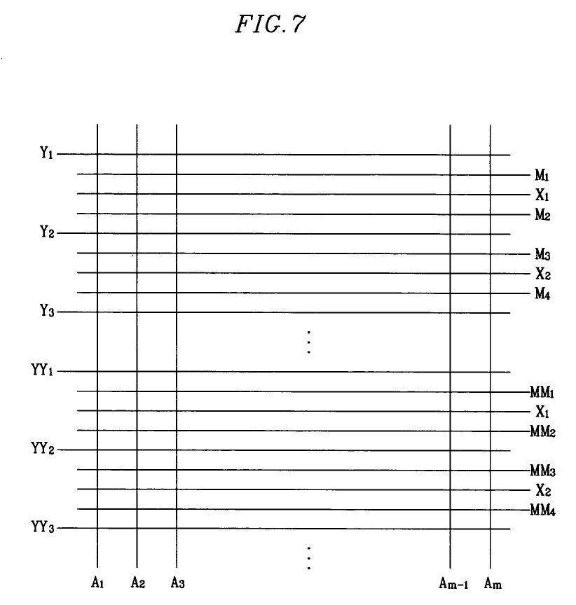

FIG. 6 shows a plasma display device according to an exemplary embodiment of the present invention.

Referring to FIG. 6, the plasma display device may include a PDP 100, an address electrode driver 200, a Y electrode driver 300, an X electrode driver 400, an M electrode driver 500, and a controller 600.

The PDP 100 includes a plurality of address electrodes A1 to Am arranged in the column direction, and a plurality of Y electrodes Y1 to Yn, X electrodes X1 to Xn, and Mij electrodes arranged in the row direction. The Mij electrodes represent electrodes formed between the Xi electrodes and Yj electrodes.

The address electrode driver 200 receives an address driving control signal S_{A} from the controller 600 and applies display data signals for selecting discharge cells to be displayed to the respective address electrodes.

The Y electrode driver 300 and the X electrode driver 400 receive a Y electrode driving signal S_{Y} and an X electrode driving signal S_{X} from the controller 600 and apply driving signals to the Y electrodes and the X electrodes, respectively.

The M electrode driver 500 receives an M electrode driving signal S_{M} from the controller 600 and applies driving signals to the M electrodes. The circuit may be simplified by providing the M electrode driver 500 and X electrode driver 400 on the same printed circuit board (PCB).

The controller 600 receives video signals, generates the address driving control signal S_{A}, the Y electrode driving signal S_{Y}, the X electrode driving signal S_{X}, and the M electrode driving signal S_{M}, and transmits them to the address electrode driver 200, the Y electrode driver 300, the X electrode driver 400, and the M electrode driver 500, respectively.

Here, the Y electrode driver 300 and the X electrode driver 400 may be coupled with opposite ends of the Y and X electrodes, respectively, and the M electrode driver 500 may be coupled with either end of the M electrodes (e.g., FIG. 6 shows the M electrode driver 500 and the X electrode driver 400 coupled with right ends of the M and X electrodes, respectively).

FIG. 7 shows an electrode arrangement configuration according to an exemplary embodiment of the present invention.

Referring to FIG. 7, the M electrodes are arranged between the Y electrodes and the X electrodes. For ease of description, reference numerals are provided at positions where the drivers for driving the X electrodes, the Y electrodes, and the M electrodes are assigned.

That is, in FIG. 7, reference numerals are provided on the left side of the Y electrodes since the Y electrode driver is coupled with the left side thereof, and reference numerals are provided on the right side of the X electrodes and the M electrodes since the X electrode driver and the M electrode driver are coupled with the right sides thereof.

The M electrodes may be scanned in the order of M₁, M₂, M₃, . . . , MM₁, MM₂, MM₃ in the case of a single sequential scan operation (assuming that the scan direction proceeds from top to bottom of the panel) in the address period in the above-described electrode arrangement configuration. The M electrodes may be scanned in the order of (M₁, MM₁), (M₂, MM₂), (M₃, MM₃) in the case of a double sequential scan operation.

In the driving waveform according to the first exemplary embodiment of the present invention, in the address period, the Y electrode is grounded and the X electrode is biased with the positive voltage of Vb. Therefore, a discharge occurs between the X electrode and the M electrode after an address discharge occurs between the address electrode and the M electrode. In this instance, a very slight discharge may occur between the Y electrode, the voltage of which is relatively lower than that of the X electrode, and the M electrode. Hence, when a rising ramp waveform is applied to the M electrode in the reset period, application of the rising ramp waveform that corresponds to an erase waveform to the Y electrode minimally influences the reset discharge.

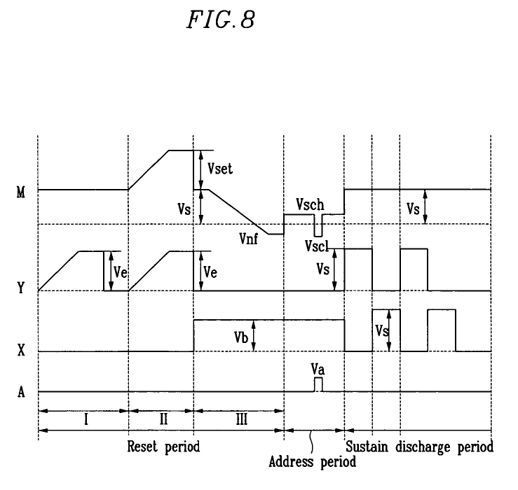

FIG. 8 shows driving waveforms according to a second exemplary embodiment of the present invention.

As shown in FIG. 4 and FIG. 8, the Y electrode driver 300 may need a ramp switch for applying rising ramp waveforms and a switch driving IC so as to apply a rising ramp waveform to the Y electrode in the erase period I. Similarly, the M electrode driver 500 may have a ramp switch for applying rising ramp waveforms and a switch driving IC so as to apply a rising ramp waveform to the M electrode in the M electrode rising waveform period II of the reset period.

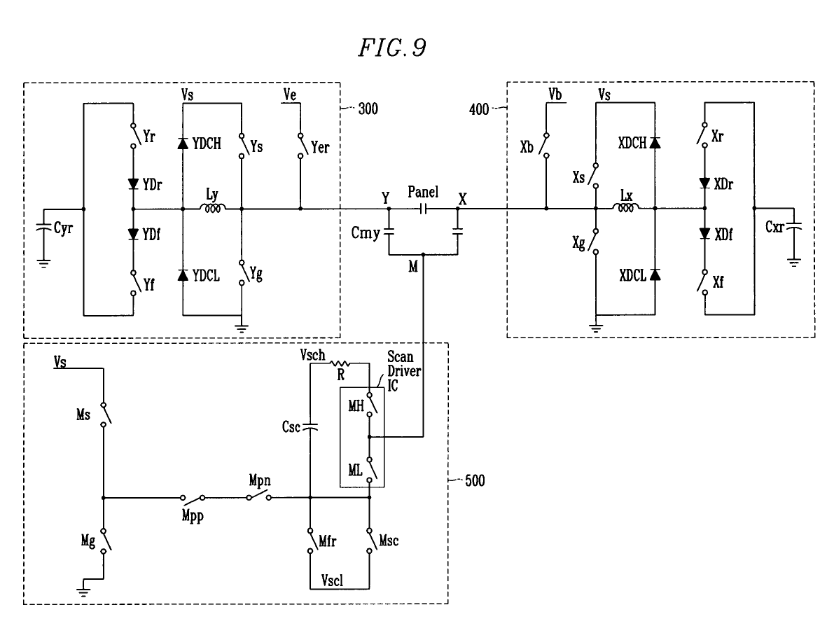

However, when a rising ramp waveform, corresponding to the erase waveform of the erase period I, is applied to the Y electrode when a rising ramp waveform is applied to the M electrode in the reset period according to the second exemplary embodiment of the present invention shown in FIG. 8, it is possible to apply a reset rising ramp waveform to the M electrode by using the rising ramp switch of the Y electrode driver 300 without providing a reset rising ramp switch in the M electrode driver. FIG. 9 shows a circuit diagram of the Y electrode driver 300, the X electrode driver 400, and the M electrode driver 500 for applying driving waveforms according to the second exemplary embodiment of the present invention.

Referring to FIG. 9, the Y electrode driver 300 may include switches Ys and Yg coupled between a power source Vs for supplying the voltage of Vs and the ground (GND). The Y electrode driver 300 may further include a power recovery capacitor Cyr, an inductor Ly, a switch Yr and a diode YDr for forming a charge path, a switch Yf and a diode YDf for forming a discharge path, and clamping diodes YDCH and YDCL.

The clamping diode YDCH, which is coupled between a drain of the switch Yf and the power source Vs, prevents the drain voltage at the switch Yf from overshooting the voltage of Vs. The clamping diode YDCL, which is coupled between a source of the switch Yr and the ground GND, prevents the voltage at the switch Yr from undershooting 0V.

The Y electrode driver 300 also includes a power source Ve coupled with a ramp switch Yer that is turned on in the erase period I and the M electrode rising waveform period II of the reset period and transmits a substantially constant current to thus apply a rising ramp waveform.

The X electrode driver 400 may include switches Xs and Xg coupled between a power source Vs for supplying the voltage of Vs and the ground GND, a power recovery capacitor Cxr, an inductor Lx, a switch Xr and a diode XDr for forming a charge path, a switch Xf and a diode XDf for forming a discharge path, and clamping diodes XDCH and XDCL. The X electrode driver 400 may further include a switch Xb coupled with a power source Vb and supplying a bias voltage of Vb to the X electrode in the M electrode falling waveform period III of the reset period and the address period.

The M electrode driver 500 may include a switch Ms coupled to the power source Vs, a falling ramp switch Mfr for generating a falling reset waveform in the M electrode falling waveform period III of the reset period, and switches Mpp and Mpn formed on a main path and preventing reverse currents.

The M electrode driver 500 may further include a capacitor Csc coupled between a power source VscH for generating a scan pulse in the address period and supplying a voltage to the non-selected M electrode and a power source VscL for supplying a voltage to the selected M electrode, and storing the voltage of VscH-VscL, a switch Msc for supplying the voltage of VscL, and a plurality of scan driver ICs coupled to the M electrodes. The scan driver ICs include two switches MH and ML for supplying the high voltage of VscH and the low voltage of VscL, respectively, to the M electrode. In this case, VscL may equal Vnf.

In the 4-electrode structured plasma display device driving circuit according to an exemplary embodiment of the present invention, a capacitor Cmy formed between the Y Is electrode and the M electrode may be charged with the voltage of Vs since the voltage of Vs is applied to the M electrode when an erase rising ramp waveform is applied to the Y electrode and the voltage at the Y electrode is reduced to the ground voltage in the erase period I of the reset period. The switch Mpp of the M electrode driver 500 is turned off in this state to float the M electrode, and the switch Yer of the Y electrode driver 500 is turned on. Hence, in the M electrode rising waveform period II, the voltage at the Y electrode gradually increases to the voltage of Ve as shown in FIG. 8, and the potential of the M electrode gradually increases from the voltage of Vs to the voltage of Vs+Ve. In this case, Ve may equal Vset.

According to the above-described driving circuit, the rising ramp switch of the M electrode driver may be eliminated by using the rising ramp switch Yer of the Y electrode driver and gradually increasing the voltage at the M electrode by floating the M electrode by turning off the switch Mpp in the reset period.

Also, the process of turning off the switches MH and ML of the scan driver IC and controlling the output of the scan driver IC to have high impedance in the reset period has substantially the same affect as that of the process of turning off the switch Mpp and floating the M electrode.

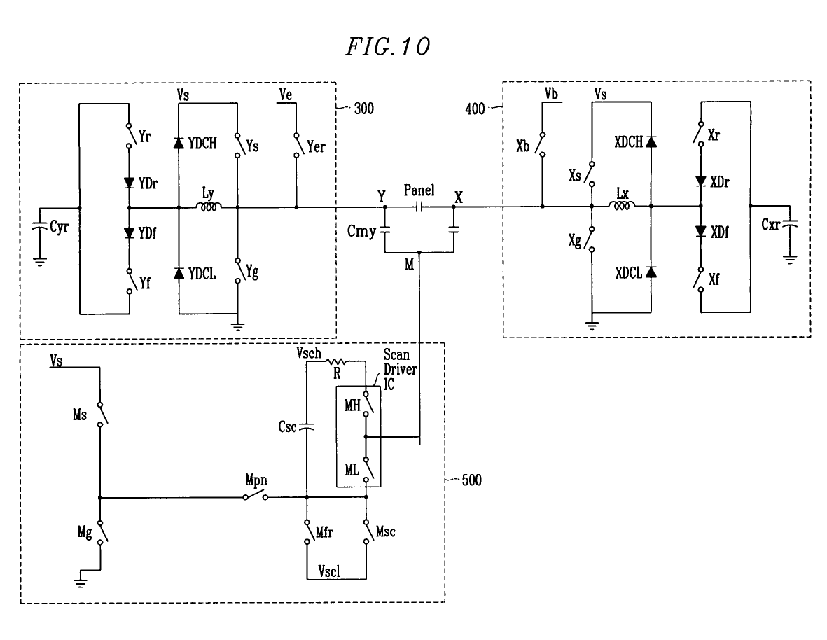

In this instance, the switch Mpp need not be turned off in the reset period. Hence, the switch Mpp may be eliminated from the M electrode driver 500 as shown in FIG. 10.

As described above, an insufficient discharge at the beginning of the sustain discharge period may be prevented by forming a middle electrode between an X electrode and a Y electrode, applying a reset waveform and a scan waveform to the middle electrode, and applying a sustain discharge voltage waveform to the X electrode and the Y electrode.

Further, the number of switches of the M electrode driver may be reduced and production costs may be decreased by floating the M electrode and applying a rising ramp waveform to the Y electrode in the reset period to increase the voltage at the M electrode.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method for driving a plasma display device including a plurality of discharge cells, a discharge cell including a first electrode, a second electrode, and a third electrode arranged between the first electrode and the second electrode, comprising:
in a reset period, gradually increasing a voltage at the first electrode from a first voltage to a second voltage, gradually increasing a voltage at the third electrode from a third voltage to a fourth voltage, and gradually decreasing the voltage at the third electrode from a fifth voltage to a sixth voltage;
in an address period, selectively applying a scan voltage to the third electrode; and
in a sustain period, alternately applying a sustain discharge pulse to the first electrode and the second electrode.

2. The method of claim 1, wherein gradually increasing the voltage at the third electrode from the third voltage to the fourth voltage comprises applying a waveform gradually increasing from the first voltage to the second voltage to the first electrode while the third electrode is floated.

3. The method of claim 1, further comprising:
in an erase period of the reset period, gradually increasing the voltage at the first electrode from the first voltage to the second voltage.

4. The method of claim 1, further comprising:
in the address period, applying a seventh voltage to the first electrode and an eighth voltage to the second electrode,
wherein the eighth voltage is higher than the seventh voltage.

5. The method of claim 1, wherein the plasma display device further comprises a fourth electrode arranged in a direction crossing the third electrode, the driving method further comprising:
in the address period, applying an address voltage to the fourth electrode when the scan voltage is selectively applied to the third electrode.

6. The method of claim 1, wherein gradually increasing the voltage at the first electrode from the first voltage to the second voltage occurs in a first part of the reset period, gradually increasing the voltage at the third electrode from the third voltage to the fourth voltage occurs in a second part of the reset period, and the first part of the reset period occurs before the second part of the reset period.

7. The method of claim 6, further comprising: gradually increasing the voltage at the first electrode from the first voltage to the second voltage in the second part of the reset period.

8. The method of claim 7, wherein gradually increasing the voltage at the third electrode from the third voltage to the fourth voltage in the second part of the reset period comprises applying a waveform gradually increasing from the first voltage to the second voltage to the first electrode while the third electrode is floated.

9. The method of claim 6, wherein gradually decreasing the voltage at the third electrode from the fifth voltage to the sixth voltage occurs in a third part of the reset period, and the third part of the reset period occurs after the second part of the reset period.

10. A plasma display device, comprising:
a plasma display panel (PDP) including a first electrode and a second electrode for respectively receiving a sustain discharge voltage pulse, and a third electrode formed between the first electrode and the second electrode; and
a driving circuit for outputting signals for driving the first electrode, the second electrode, and the third electrode,
wherein the driving circuit comprises:
a first electrode driver including a first switch and a second switch coupled in series with each other between a first power source for supplying a first voltage that is a higher voltage of the sustain discharge pulse and a second power source for supplying a second voltage that is a lower voltage of the sustain discharge pulse, and a third switch coupled between a third power source for supplying a third voltage and the first electrode, a node of the first switch and the second switch being coupled with the first electrode, and the third switch gradually increasing a voltage at the first electrode; and
a third electrode driver including a fourth switch coupled between a fourth power source for supplying a fourth voltage and the third electrode, the fourth switch for gradually decreasing a voltage at the third electrode, and
wherein in a reset period, the voltage at the third electrode is gradually decreased by turning on the fourth switch after the voltage at the third electrode is gradually increased by turning on the third switch while the third electrode is floated.

11. The plasma display device of claim 10, wherein the third electrode driver further comprises:
a fifth switch having a first terminal coupled with a fifth power source for supplying a fifth voltage; and
a sixth switch coupled between a second terminal of the fifth switch and the third electrode,
wherein in the reset period, the third electrode is floated by turning off the fourth switch.

12. The plasma display device of claim 11, wherein the third electrode driver further comprises:
a plurality of selection circuits respectively including a seventh switch having a first terminal coupled with the third electrode and applying a scan voltage to a selected third electrode, and an eighth switch having a second terminal coupled with the third electrode and supplying a non-scan voltage to an unselected third electrode; and
a ninth switch coupled between a first terminal of the selection circuit and a sixth power source for supplying the scan voltage,
wherein in the reset period, the third electrode driver turns off the seventh switch and the eighth switch to float the third electrode.

13. The plasma display device of claim 10, wherein the driving circuit further comprises:
a second electrode driver including a tenth switch and an eleventh switch coupled in series with each other between a power source supplying the first voltage and a power source supplying the second voltage, a node of the tenth switch and the eleventh switch being coupled with the second electrode.

14. The plasma display device of claim 10, wherein the PDP further comprises a fourth electrode arranged in a direction crossing the third electrode, and
wherein the driving circuit further comprises a fourth electrode driver for applying an address voltage to the fourth electrode when a scan voltage is selectively applied to the third electrode in an address period.
